(19) United States
(12) Patent Application Publication
(10) Pub. No.: US 2022/0163148 A1
(43) Pub. Date: May 26, 2022

(54) FLEXIBLY INSERTABLE PROFILED CLAMP

(71) Applicant: NORMA Germany GmbH, Maintal (DE)

(72) Inventors: Markus Krämer, Maintal (DE); Natan Lantsmann, Maintal (DE)

(21) Appl. No.: 17/602,518

(22) PCT Filed: Mar. 30, 2020
(86) PCT No.: PCT/EP2020/058992

§ 371 Date: Oct. 8, 2021

(30) Foreign Application Priority Data
Apr. 8, 2019 (DE) 10 2019 109 196.9

(51) Int. Cl. F16L 23/06

(52) U.S. Cl. CPC F16L 23/06

(57) ABSTRACT

A profiled clamp having a clamp band and a clamping device which has two clamping jaws arranged at a distance (D) from one another in the circumferential direction (U). The clamping jaws are arranged on each end of the clamp band and can be moved towards one another by means of at least one clamping means. On an inner side of the clamp band, at least two profiled segments are arranged circumferentially spaced apart from one another. The profiled segments can be connected to the clamp band in each case by means of at least one latching connection.

The disclosure relates to a profiled clamp having a clamping band and a clamping device which has two clamping jaws which are arranged with spacing from each other in a peripheral direction.

For fluid-tight connection of two lines, profiled clamps are generally used. Such lines have connection flanges which are arranged at the end side and which protrude radially beyond the respective line. The profiled clamp may engage around and axially press together the connection flanges of the lines at the end faces thereof facing away from each other. The pressing together of the connection flanges is carried out by means of the principle of the inclined plane. To this end, the profiled clamp has profile segments having a profile which tapers radially outward.

Profiled clamps are often produced completely from a metal in order to be able to introduce corresponding clamping forces. In this instance, profile segments are generally secured to a clamping band by means of weld connections or solder connections or the clamping band is itself provided with a corresponding profile cross section. The production of the profiled clamps is particularly complex as a result of the introduction of the weld connections and limits the material selection. Furthermore, metal profiled clamps may damage sensitive or fragile connection flanges which, for example, comprise a plastics material or a glass.

### SUMMARY

An object of the disclosure, according to an embodiment, is therefore to provide a profiled clamp which can be produced with little complexity and which can also be used with connection flanges made of sensitive materials.

The disclosure, according to an embodiment, relates to a profiled clamp having a clamping band and a clamping device. The clamping device has two clamping jaws which are arranged with spacing from each other in a peripheral direction. The clamping jaws are arranged in each case at the end side on the clamping band. As a result of at least one clamping means, the clamping jaws can be moved toward each other. As a result of the clamping means, the spacing between the clamping jaws can be reduced and the profiled clamp is clamped or closed. At least two profile segments which are spaced apart from each other at the peripheral side are arranged at an inner side of the clamping band, wherein the profile segments are connected to the clamping band by means of at least one latching connection.

The clamping band and the clamping jaws may be produced from a metal material. The clamping means of the clamping device may, for example, be configured in the form of a releasable or non-releasable screw connection or as an adjustable or rigid toggle lever closure or the like.

The profile segments are secured to the clamping band by means of latching connections, per an embodiment. A welding or soldering to secure the profile segments may thereby no longer be necessary. Consequently, different material combinations can be used in the profiled clamp according to certain embodiments. In particular, material combinations which cannot be welded or soldered to each other can be used. The profile segments may, for example, be produced from a fiber composite material, an elastomer material, a thermoplastic, a thermosetting plastic and the like. The profile segments may also comprise a metal material, wherein, as a result of the latching connections, the assembly of the profile segments on the clamping band can be simplified and accelerated.

Such a profiled clamp may have profile segments made of a “soft” material in comparison with a metal and consequently also be able to be used in connection flanges of glass, composite materials or plastics materials.

According to an embodiment, the clamping band has at least one opening in order to construct the latching connection. At least one locking element which can be inserted into the opening of the clamping band is arranged at a side of the profile segment facing the clamping band. The at least one latching connection can consequently be constructed by means of the cooperation of the opening with at least one locking element of the profile segment.

The clamping band may have for each profiled clamp used at least one opening which in each case can receive at least one locking element of the profiled clamp. Advantageously, per certain embodiments, a locking element may be able to be inserted into each opening. In this instance, the dimensions of the opening may be sized in such a manner that the locking element can protrude and engage therein in a positive-locking manner. Each profile segment can thereby be positioned in a fixed manner on the clamping band by means of at least one constructed latching connection. Alternatively or additionally, there may be provided at least one opening which is formed in an elongate manner in the peripheral direction of the clamping band, wherein such an opening may also receive a plurality of locking elements of one or more profile segments in order to form a plurality of latching connections.

The openings may be introduced in a centered state in the clamping band in an axial direction or transversely relative to the peripheral direction of the clamping band. In a similar manner, the locking elements may be arranged in a centered state in an axial direction at a side of the profile segment facing the clamping band.

The latching connection may be configured in a technically particularly simple manner and may be able to be produced rapidly if the locking element of the profile segment can be inserted into the at least one opening of the clamping band in a positive-locking and/or frictionally engaging manner. An insertion of the profile segments into the clamping band which is carried out manually or in an automated manner may thereby be sufficient to form a permanent connection between the clamping band and the profile segments.

According to another embodiment, the opening of the clamping band has an elongate shape which is orientated in the peripheral direction of the clamping band. An opening formed in an elongate manner can be used to receive a plurality of locking elements. Alternatively or additionally, one or more locking elements may be inserted into the elongate opening and may form a latching connection which can be moved in a peripheral direction. The elongate opening consequently acts as a rail and enables a defined movability of the profile segments in a peripheral direction, that is to say, along the path of the opening or the clamping band. The friction force which is produced between the profile segments and the connection flanges when the profiled clamp is clamped can thereby be reduced.

According to another embodiment, the at least one locking element is arranged at the side of the profile segment facing the clamping band and constructed in a materially engaging manner therewith. The profile segment may comprise a plastics material and have one or more rear-side locking elements for producing latching connections with the clamping band. Such a profile segment may, for example, be produced by means of an injection-molding method. Alternatively, such profile segments with locking elements may also be produced by means of additive production methods. The locking elements may also be positioned subsequently on the rear of the profile segments, for example, by means of adhesive bonding or welding. The rear side of a profile segment is the side of the profile segment facing the clamping band.

Locking elements may be produced in a technically particularly simple manner if the at least one locking element is introduced in a punched and/or bent state into the profile segment. The profile segment may thereby comprise a plastics material or a metal. At the latching connection locations, under the action of pressure and temperature material can be pressed at the rear side out of the profile segment and form the locking element. The material which has been pressed out of the rear side may be able to be used to produce a positive-locking or frictionally engaging latching connection.

According to another embodiment, the at least one profile segment has a round, a rectangular, a triangular or a trapezoidal profile which is open at a side facing away from the clamping band. The profile segment has in this instance two profile flanks which are connected to each other by means of a profile base. Differently shaped profile segments may be combined with a clamping band which can be used universally. In particular, profiled clamps which differ only in terms of the profile segments can thereby be provided by only the profile segments being varied. Consequently, the production process can be simplified.

According to another embodiment, the clamping band is constructed from an identical material to or a different material from the at least two profile segments. As a result of the latching connection, materials which cannot be adhesively-bonded or welded to each other can be combined with each other. For example, the clamping band with the clamping device may comprise a metal and the profile segments may comprise a plastics material. In particular, the profile segments may comprise a fiber-reinforced plastics material, a carbon, an elastomer material and the like. The profile segments may alternatively or additionally be at least partially stiffened or reinforced by means of metal strips or ribs. In this instance, the profile segments may also comprise a metal base member which is covered by a plastics material.

Since the profile segments are no longer welded to the clamping band, but instead “clicked” into each other by means of a latching connection, a larger variety of material is enabled for the production of the profiled clamp.

The use of separate seals and intermediate rings between the connection flanges can be dispensed with if a sealing element can be positioned on at least one profile segment. The sealing element, per an embodiment, preferably extends at the inner side of the profile segments facing away from the clamping band. For example, the sealing element may be configured in the form of a sealing ring or an annular flat seal which extends in a peripheral direction along the inner side of the profile segments and extends radially inward. Preferably, per an embodiment, the sealing element is uninterrupted, that is to say, constructed as a closed circle, and is at least partially connected to the clamping band and/or to at least one profile segment. An orientation of the sealing element with respect to the connection flanges can thereby be dispensed with.

The sealing element can be arranged and orientated in a particularly simple manner on the profile segments if at least one thin plate for receiving the sealing element is arranged at the inner side of the profile segment facing away from the clamping band.

Preferably, per an embodiment, the at least one thin plate is introduced into the open profile in a state centered in an axial direction. The sealing element may have a radially introduced recess or groove in which the thin plate can protrude and fix the sealing element. In particular, the at least one thin plate may be able to be combined with different sealing elements.

According to another embodiment, the at least one thin plate is configured to be rigid or flexible in an axial direction. Depending on the application of the profiled clamp, an axial compensation when the connection flanges are positioned in the profile segments of the profiled clamp can thereby be enabled. With thin plates which are configured in a rigid manner, a fixed connection location in the profiled clamp can be defined as a connection location of the connection flanges.

### BRIEF DESCRIPTION OF THE FIGURES

Other features, details and advantages of the disclosure will be appreciated from the wording of the claims and from the following description of embodiments with reference to the drawings, in which:

FIG. 1 is a perspective illustration of a profiled clamp according to an embodiment,

FIG. 2 is a cross section A-A from FIG. 1

FIG. 3 is a perspective illustration of a profiled clamp according to another embodiment, and

FIG. 4 is a cross section B-B from FIG. 2.

### DETAILED DESCRIPTION

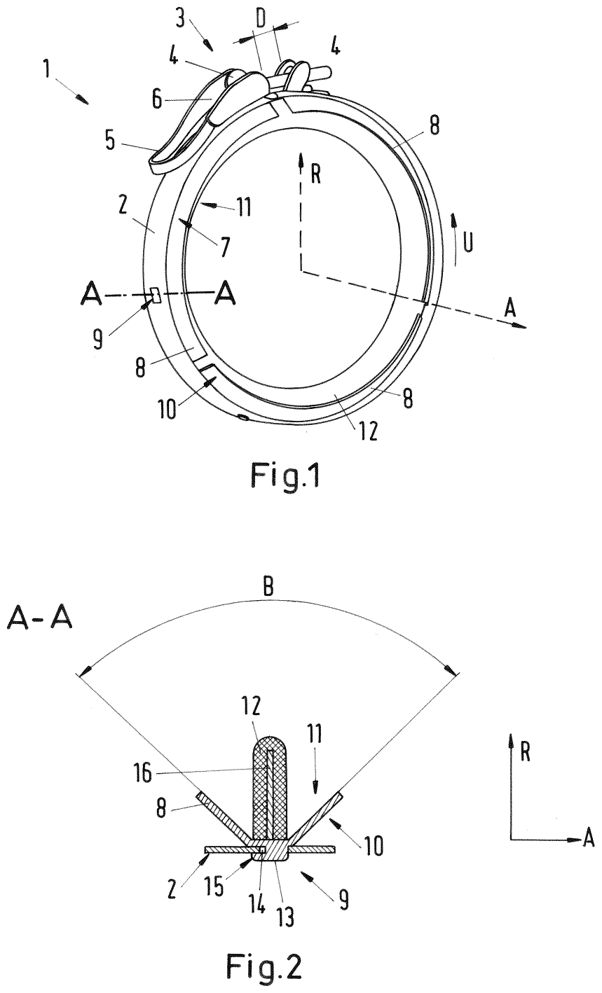

FIG. 1 is a perspective view of a profiled clamp 1 according to an embodiment. The profiled clamp 1 has a clamping band 2 and a clamping device 3. The clamping band 2 is produced from a metal or a metal alloy, such as, for example, high-grade steel.

The clamping device 3 has two clamping jaws 4 which are arranged in a peripheral direction with a spacing D with respect to each other. The clamping jaws 4 are arranged in each case at the end of the clamping band 2. As a result of at least one clamping means 5, the clamping jaws can be moved toward each other. According to the embodiment illustrated, the clamping device 3 is configured as a toggle lever closure.

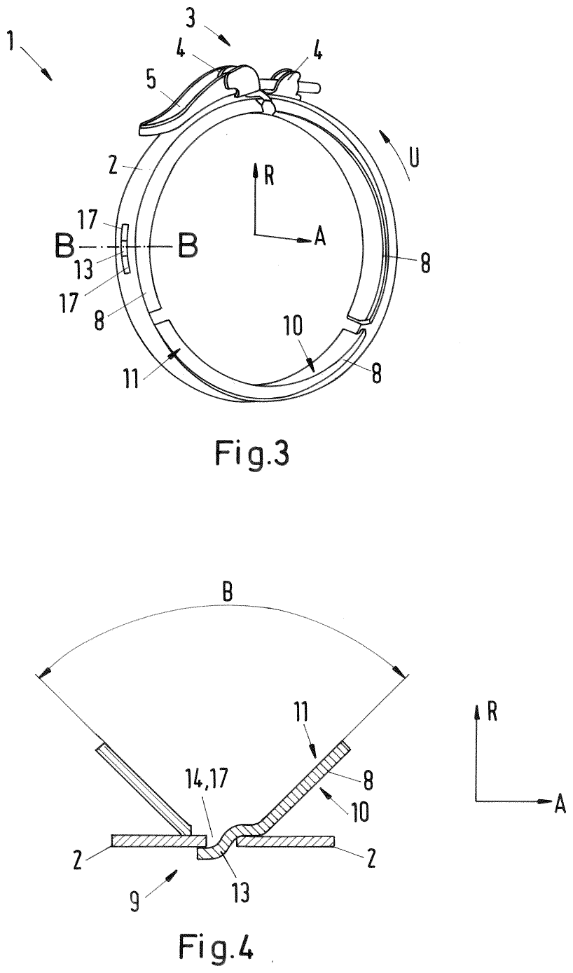

A lever which can be adjusted by means of a screw 6 is used as a clamping means 5. Using the screw 6, the spacing D between the clamping jaws 4 in the closed state of the clamping means 5 can be adjusted. In FIGS. 1 and 3, the clamping device 3 is illustrated in a closed state.

At an inner side 7 of the clamping band 2, according to the embodiment three profile segments 8 are arranged. The profile segments 8 are spaced apart from each other in a peripheral direction U. To this end, the profile segments 8 are connected to the clamping band 2 in a fixed manner by means of latching connections 9.

The profile segments 8 have a side 10 or rear side facing the clamping band 2 and an inner side 11 facing away from the clamping band 2. At the rear side 10, the profile segments 8 are coupled to the inner side 7 of the clamping band 2 by means of latching connections 9. According to an embodiment, each profile segment 8 is arranged on two latching connections 9 with the clamping band 2.

At the inner side 11 of the profile segment 8 facing away from the clamping band 2, a sealing element 12 is provided. The sealing element 12 is configured as an annular sealing lip and extends at the peripheral side inside the profile segments 8.

FIG. 2 shows a cross section A-A from FIG. 1 to illustrate the structure of a latching connection 9. The latching connection 9 is constructed by means of cooperation of a locking element 13 with an opening 14 which is constructed in the clamping band 2.

The locking element 13 is constructed on the rear side 10 of the profile segment 8. According to the example illustrated, the profile segment 8 may be produced in one piece or integrally with the at least one locking element 13. For example, the profile segment 8 and the at least one locking element 13 may be produced from a plastics material or a fiber-reinforced plastics material.

The opening 14 is introduced into the clamping band 2. For example, a plurality of openings 14 may be punched with a defined spacing from each other in the clamping band 2. The opening 14 and the locking element 13 have a rectangular basic shape in this embodiment.

The locking element 13 is in an axial direction A formed to be slightly larger than an axial extent of the opening 14 as a result of a projection 15. It is thereby possible, using a defined application of force in a radial direction R for a locking element 13 to be pushed through the opening 14 and latched or locked. As a result of this cooperation, a latching connection 9 is produced. To this end, the locking element 13 may also have an undercut in which an edge of the opening 14 can engage.

The profile segment 8 has a trapezoidal profile which at the rear side 10 thereof has the at least one locking element 13 and is open at the inner side 11 facing away from the clamping band 2. The opening angle B between the profile flanks of the profile segment 8 is 90° in this embodiment. However, the opening angle B may also be greater or less than 90°.

At the inner side 11 of the profile segment 8 which is configured to be open, a thin plate 16 is arranged. The thin plate 16 extends in a radial direction R from the profile segment 8 and is introduced into a slot of the sealing element 12. The thin plate 16 may be connected to the profile segment 8 in a positive-locking or materially engaging manner and consequently position the sealing element 12 at least in a peripheral and/or axial direction in a fixed manner with respect to the profile segment. In this instance, there may be provision for no fixing to be provided in the radial direction in order in the event of the diameter reduction which occurs as a result of the clamping of the profiled clamp to enable a relative movement between the sealing element and the profile segment. According to an alternative embodiment, the thin plate 16 may be stamped in an annular manner and be inserted without a fixed connection in the opening angle B of the profile segments in a non-releasable manner.

The profile segments 8 serve to receive connection flanges (not illustrated) of two lines. Preferably, in an axial direction A at both sides of the sealing element 12 a connection flange of a line may be arranged and, as a result of the closure of the clamping device 3, the connection flanges may be pressed by means of the profile segments 8 axially toward each other and against the sealing element 12.

FIG. 3 illustrates a profiled clamp 1 according to another embodiment. In contrast to the profiled clamp 1 shown in FIG. 1, no sealing element is provided in this instance. Furthermore, the openings 14 in a peripheral direction U are sized to be significantly larger than the locking elements 13 of the profile segments 8. For example, the openings may have two to ten times the extent in a peripheral direction U compared with an extent of the locking elements 13. As a result of such elongate openings 17, the profile segments 8 can be moved on the latched locking elements 13 in a peripheral direction U. In this instance, the elongate openings 17 act as guides in which a movement of the profile segments 8 in a peripheral direction is possible. Since the profile segments 8 can be displaced in the openings 17, a friction force when the profiled clamp 1 is clamped between the profile segments 8 and connection flanges can be reduced.

FIG. 4 illustrates the cross section B-B from FIG. 3. Here, it is shown that the locking elements 13 have been introduced into the profile segments 8 by means of a punching/bending process. Profile segments 8 which have been punched in this manner may be produced from a metal sheet. The locking elements 13 are in an axial direction A slightly larger than the openings 17 and can consequently be inserted into the openings in a frictionally engaging and/or positive-locking manner.

Depending on the shape of the locking elements 13, the profile segments 8 may be able to be inserted laterally or from an axial direction obliquely into the openings 14, 17 provided for this purpose. Alternatively, the profile segments 8 may be able to be latched in a radial direction R in the openings 14, 17.

The invention is not limited to one of the embodiments described above, but instead can be modified in many ways. Thus, for example, more than two or three profile segments may also be provided. Furthermore, the profile segments may, for example, also be constructed in several parts with two flank elements which each have at least one locking element which is received in different or common openings in the clamping band.

All of the features and advantages derived from the claims, the description and the drawings, including structural details, spatial arrangements and method steps, may be inventively significant both individually and in extremely varied combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Profiled clamp

2 Clamping band

3 Clamping device

4 Clamping jaw

5 Clamping means

6 Adjustment screw of the clamping means

7 Inner side of the clamping band

8 Profile segment

9 Latching connection

10 Rear side of the profile segment

11 Inner side of the profile segment

12 Sealing element

13 Locking element

14 Opening

15 Projection

16 Thin plate

17 Elongate opening

A Axial direction

B Opening angle of the profile segment

D Spacing of the clamping jaws

R Radial direction

U Peripheral direction

1. A profiled clamp having a clamping band and a clamping device, wherein at least two profile segments which are spaced apart from each other at the peripheral side are arranged at an inner side of the clamping band, wherein the at least two profile segments are connected to the clamping band by means of at least one latching connection.

2. The profiled clamp as claimed in claim 1, wherein the clamping band has at least one opening in order to construct the at least one latching connection, wherein at least one locking element which can be inserted into the at least one opening is arranged on a rear side of the profile segment facing the clamping band.

3. The profiled clamp as claimed in claim 2, wherein the at least one locking element of the profile segment can be inserted into the at least one opening of the clamping band in a positive-locking and/or frictionally engaging manner.

4. The profiled clamp as claimed in claim 2, wherein the at least one opening of the clamping band has an elongate shape which is orientated in a peripheral direction (U) of the clamping band.

5. The profiled clamp as claimed in claim 2, wherein the at least one locking element is arranged at the side of the profile segment facing the clamping band and is constructed in a materially engaging manner with the profile element facing the clamping band.

6. The profiled clamp as claimed in claim 2, wherein the at least one locking element is introduced into the profile segment in a punched state and/or by means of bending.

7. The profiled clamp as claimed in claim 1, wherein at least one profile segment has a round, a rectangular, a triangular or a trapezoidal profile which is open at an inner side facing away from the clamping band.

8. The profiled clamp as claimed in claim 1, wherein the clamping band is formed from a different material from the at least two profile segments.

9. The profiled clamp as claimed in claim 1, wherein a sealing element can be positioned on at least one profile segment, wherein the sealing element extends at the inner side of the profile segments facing away from the clamping band.

10. The profiled clamp as claimed in claim 9, wherein at least one thin plate for securing the sealing element is arranged at the side of the profile segment facing away from the clamping band.
